(19) United States
(12) Patent Application Publication
(10) Pub. No.: US 2014/0132285 A1
(43) Pub. Date: May 15, 2014

(54) METHOD FOR VERIFYING CORRECT ADHESION OF A SUBSTRATE ON AN ELECTRICALLY AND THERMALLY CONDUCTIVE BODY

(71) Applicants: Hagen Friede, Waldheim (DE); Hartmut Selter, Grefrath (DE); Claus Becker, Iserlohn (DE)

(72) Inventors: Hagen Friede, Waldheim (DE); Hartmut Selter, Grefrath (DE); Claus Becker, Iserlohn (DE)

(73) Assignee: PIERBURG PUMP TECHNOLOGY GMBH, NEUSS (DE)

(21) Appl. No.: 14/130,679

(22) PCT Filed: Jun. 6, 2012
(86) PCT No.: PCT/EP2012/060685

§ 371 Date: Jan. 3, 2014

(30) Foreign Application Priority Data
Jul. 5, 2011 (EP) 11172700.4

(51) Int. Cl. G01N 27/22

(52) U.S. Cl. CPC G01N 27/22
USPC 324/658

(57) ABSTRACT

A method of verifying a correct adhesion of a substrate on a body which is configured to be electrically conductive and thermally conductive includes providing the body, providing the substrate comprising a top face and a rear face, connecting to the top face of the substrate an electric circuit comprising conductive paths and electronic components, attaching to the rear face the body via an adhesive layer comprising an adhesive, connecting the conductive paths and the body to an respective opposite terminal of a voltage source via contact tabs, measuring a capacity, and determining a quality of the adhesive layer from the measured capacity.

### CROSS REFERENCE TO PRIOR APPLICATIONS

This application is a U.S. National Phase application under 35 U.S.C. §371 of International Application No. PCT/EP2012/060685, filed on Jun. 6, 2012 and which claims benefit to European Patent Application No. 11172700.4, filed on Jul. 5, 2011. The International Application was published in German on Jan. 10, 2013 as WO 2013/004446 A1 under PCT Article 21(2).

### FIELD

The present invention relates to a method for verifying a correct adhesion of a substrate on an electrically and thermally conductive body, wherein an adhesive layer is formed between the substrate, on the top face of which an electric circuit with conductive paths and electronic components is arranged, and the electrically conductive body being fixed on the rear face of the substrate.

### BACKGROUND

Substrates are used to control electromotively driven pumps that comprise control and power components electrically connected with each other via conductive paths. Both the power components and, depending on the installation site, the environment generates heat that must be dissipated from the electric components on the respective substrate in order to avoid damage to the circuits caused by excessive thermal loads. For this reason, the substrates are mounted on cooling bodies typically made of a metal with good heat conductivity, in particular aluminum, and which either surrounded by a flow of a coolant on their side opposite the substrate in order to dissipate heat or comprise ribs that allow the dissipation of heat to an air flow. This fastening of the substrate on the aluminum cooling body may be effected in a non-positive, material bonding, or positive manner. The connection must be realized over as large an area as possible and with the minimum possible distance to the cooling body to be connected for a sufficient heat dissipation from the substrate to the cooling body to also be provided at high thermal loads.

DE 100 51 945 C1 describes the mounting of a substrate for a motor vehicle electronic component, wherein the connection is made using a thermally conductive adhesive.

Currently unpublished European Patent Application EP 11165116.2 describes making this adhesion by creating a vacuum between the cooling body and a ceramic substrate, whereby thin adhesive layers extending over the entire surface can also be achieved with ceramic substrates that have a tendency to break.

Heat conductivity is here better the thinner the adhesive surface and the larger the surface over which it extends. It is necessary for this reason, when checking the adhesion, to be able to evaluate both the thickness of the adhesive layer and the possible presence of air inclusions in the area of the adhesive layer.

JP 4344402 AA describes determining the thickness of a multi-layered substrate by measuring the capacity of a capacitor formed by a conductive layer on a front face and a rear face of the substrate. An evaluation of the quality of an adhesive connection between cooling bodies and substrates is not made.

### SUMMARY

An aspect of the present invention is to provide a method for verifying the correct adhesion of a substrate on an electrically and thermally conductive body which allows for a reliable evaluation of the adhesive layer thickness and the full-surface character of the adhesion and thus of the quality of the adhesion so that a sufficient heat dissipation from the components can be provided.

In an embodiment, the present invention provides a method of verifying a correct adhesion of a substrate on a body which is configured to be electrically conductive and thermally conductive includes providing the body, providing the substrate comprising a top face and a rear face, connecting to the top face of the substrate an electric circuit comprising conductive paths and electronic components, attaching to the rear face the body via an adhesive layer comprising an adhesive, connecting the conductive paths and the body to an respective opposite terminal of a voltage source via contact tabs, measuring a capacity, and determining a quality of the adhesive layer from the measured capacity.

### BRIEF DESCRIPTION OF THE DRAWINGS

The present invention is described in greater detail below on the basis of embodiments and of the drawings in which:

FIG. 1 shows a schematic side elevational view of a substrate adhered to a cooling body;

FIG. 2 shows a schematic top plan view on the substrate with the contact tabs connected; and

FIG. 3 shows a flow chart of a test specification.

### DETAILED DESCRIPTION

A non-destructive layer thickness measuring and quality evaluation becomes possible in a simple manner because the conductive paths and the electrically conductive body are each connected to the opposite terminals of a voltage source via contact tabs, with the quality of the adhesive layer being concluded from the capacity measured. The electrically and thermally conductive body on the one hand and the conductive paths on the other hand here act as opposite plates of a plate capacitor, with a known thickness of the non-conductive circuit support and an adhesive thickness to be determined existing between the plates. The capacity here depends on the layer thickness as well as on the dielectric constant of the adhesive layer that varies in the presence of air inclusions so that the capacity is a measure of the quality and the thickness of the adhesive layer.

In an embodiment of the present invention, the contact tabs can, for example, be connected to the conductive paths via the supply contacts of the circuit. The supply contacts are easily accessible. A connection at this position is further reproducible, whereby measuring errors caused by capacitive coupling between the wires of the contact tabs can be removed.

In an embodiment of the method of the present invention, the dielectric constant of the adhesive used is first determined, whereby erroneous measuring results caused by adhesive-free areas with varying dielectric constants do not occur.

Measuring results can be improved when an offset compensation is performed immediately before connecting the contact tabs with the conductive body and the conductive paths. This zeroing of the measurement at a defined distance of the contact tabs to the substrate eliminates the influences of a capacitive coupling or of the air humidity.

In an embodiment of the present invention, the measured capacity can, for example, be compared to an upper and a lower limit value for the capacity and, if the capacity falls into the interval between the lower limit value and the upper limit value, a correct adhesion is concluded therefrom. The interval may be chosen to be relatively small since a high measuring accuracy is given. If the limit values are not exceeded, a full-surface and sufficiently thin adhesive layer can thus be concluded therefrom.

Such a method provides the adhesion between the substrate and a thermally and electrically conductive body, whereby a sufficient heat dissipation from the thermally loaded substrate is provided so that a failure of thermally sensitive electronic components is reliably avoided. It is thereby possible to evaluate the quality of adhesion both with respect to the layer thickness and possible air inclusions.

The method of the present inventions is described hereunder with reference to the drawings.

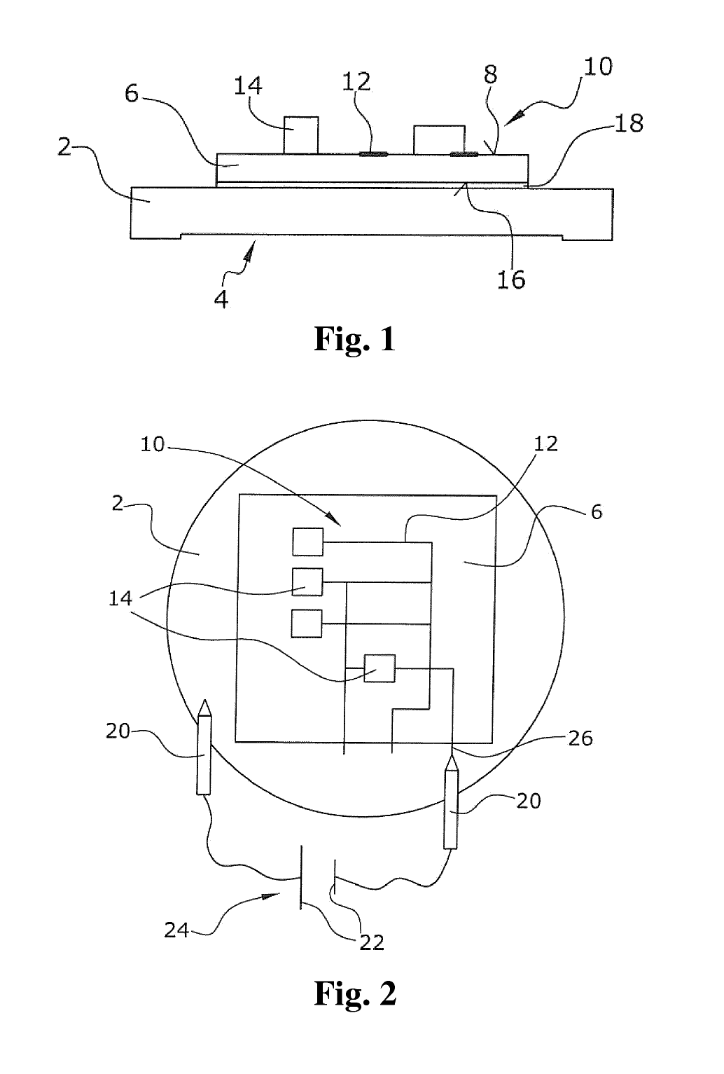

FIG. 1 illustrates a body 2 made of a thermally and electrically conductive metal, such as aluminum, and serving as a cooling body which, after installation, is surrounded by a flow of a liquid coolant, for example, at its bottom face 4.

A substrate 6 is fixed on the body 2, which substrate 6 may, for example, be made of ceramics, and which has an electric circuit 10 arranged on the top face 8 thereof, which is formed by printed electric conductive paths 12 and electronic components 14 connected therewith which may, for example, include electric power semiconductors. Other circuit materials such as FR4 and other methods for making the conductive paths, for example, by an etched or laminated copper film, are also conceivable.

The connection between the rear face 16 of the substrate averted from the electric circuit 10 and the body 2 is realized using a thermally conductive adhesive that is electrically insulating and thermally conductive. The adhesive has a viscosity of about 200,000 mPa so that it is pasty, can be dosed well, and does not have a tendency to drip. The adhesive is applied in a spiral shape as a bead of adhesive and, subsequently, air is extracted from the interstices by means of a vacuum, whereby, by the subsequent application of atmospheric pressure on the top face 8 of the substrate 6, a full-surface adhesion is achieved owing to the pressure difference between the top face 8 and the rear face 16.

The adhesive layer 18 thus formed should be 100 μm thick and uniform. A minimum thickness of about 50 μm is given by the admixture of solids to the adhesive. An optimized dissipation of heat from the substrate 6 or from the electronic components provided on the substrate 6 towards the cooling body 2 is thereby provided.

According to the present invention, the body 2 and the printed electric conductive paths 12 are connected to the opposite terminals 22 of a voltage source 24 via two contact tabs 20, as illustrated in FIG. 2, for the purpose of verifying the quality of adhesion and thus of the heat transfer. The connection to the printed electric conductive paths 12 is made via the supply contacts 26 of the electric circuit 10.

As a consequence of this connection, the printed electric conductive paths 12 form a first plate of a capacitor and the body 2 forms an opposite second plate of a capacitor having a capacity that depends on the insulating material present between the plates, which material is formed by the substrate 6 and the adhesive layer 18.

The capacity of a plate capacitor is calculated in a manner known per se by the equation (1):

$$C = \frac{A}{\frac{d}{{ɛ}_{0} \cdot {ɛ}_{r}}} \qquad ( 1 )$$

where C is the capacity,
A is the effective overlapping surface of both plates,
d is the distance between the plates,
εᵣ is the relative dielectric constant of the material between the plates,
ε₀ is the absolute dielectric constant (8.85419*10^{—12} ASV⁻¹m⁻¹).

In the present case, a two-layered structure is obtained between the plates of the capacitor so that equation (2) is obtained:

$$C = \frac{A}{\frac{{d}_{1}}{{ɛ}_{0} \cdot {ɛ}_{r 1}} + \frac{{d}_{2}}{{ɛ}_{0} \cdot {ɛ}_{r 2}}} \qquad ( 2 )$$

where d₁ is the layer thickness of the substrate 6,
d₂ is the layer thickness of the adhesive layer 18,
εᵣ₁ is the relative dielectric constant of the substrate material,
εᵣ₂ is the relative dielectric constant of the adhesive.

The variable in this equation (2) is the thickness of the adhesive layer d₂ that is suitably determined by transposing equation (2):

$${d}_{1} = {ɛ}_{r 2} \cdot ( \frac{{ɛ}_{0} \cdot A}{C} - \frac{{d}_{1}}{{ɛ}_{r 1}} ) \qquad ( 3 )$$

Whereas the substrates used are known with respect to their thickness, as well as with respect to their relative dielectric constant, and also the overlapping surface of the two parts of the capacitor acting as plates is known, the relative dielectric constant of the adhesive should possibly be determined in advance in a manner known per se for each newly produced batch. The capacity is thereafter measured, from which the thickness or the quality of the adhesive layer 18 can be determined using equation (3). The capacity can be measured for example by means of a Wavetek LCR 55.

For the elimination of air humidity, as well as the capacitive coupling of the two conductor wires of the contact tabs 20, an offset compensation is performed at a defined distance of 1 cm, for example, immediately before the contact tabs 20 are placed on the supply contacts 26 and the body 2. The contact tabs 20 should here possibly be arranged relative to each other similar to their arrangement during the actual measuring.

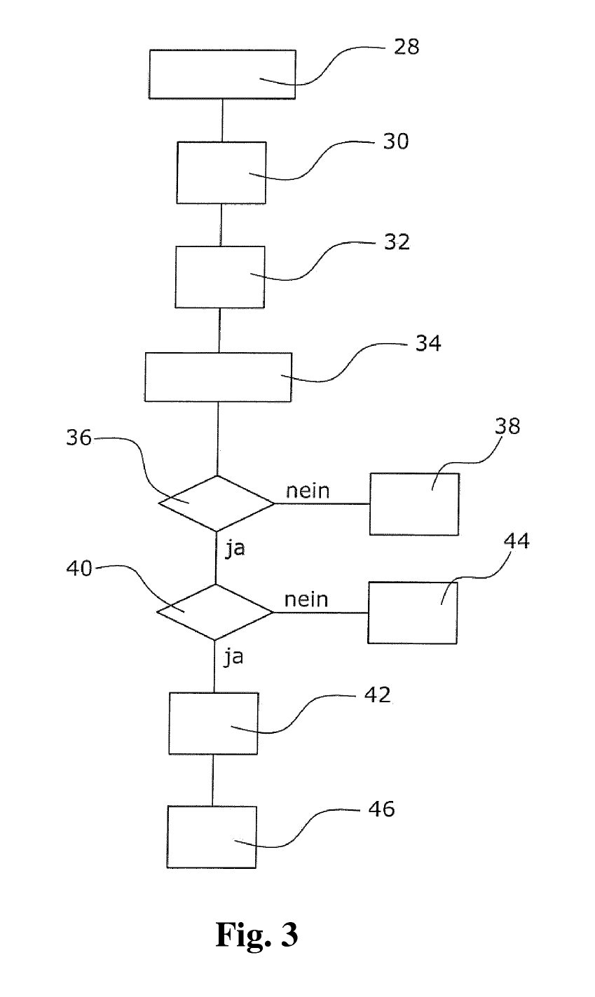

By appropriately performed reference measurements, an upper limit value C_{o of, for example,} 300 pF, as well as a lower limit value Cᵤ of, for example, 225 pF are defined as the interval for the capacity in which a sufficient quality of the adhesion is concluded/deduced. According to the flowchart in FIG. 3, capacity measuring is thus started in step 28. The lower and the upper limit value are entered in the next step 30. Measuring is started by applying a voltage at the defined points in step 32, and a value Kᵢₛₜ is measured. Of course, several measurements can be made and these can be subjected to a measured value correction in step 34, for example, by variance estimation using the Gaussian law of error propagation, so that a corrected capacity Cₖₒᵣ is obtained. Other known measured value correction methods can also be used. In the next step 36, the corrected measured value Cₖₒᵣ is compared with the lower limit value Cᵤ. If Cₖₒᵣ is smaller than Cᵤ, the adhesion is judged defective and the unit formed by substrate 6 and body 2 is rejected as indicated by the reference numeral 38. Otherwise, the corrected measured value Cₖₒᵣ is compared with the upper limit value Cₒ in step 40. The process continues to step 42, in which the unit is judged flawless if Cₖₒᵣ should be less than Cₒ. Otherwise, the process continues to step 44 and the unit is judged defective. The process ends with step 46.

It becomes clear that, with too large a thickness of the adhesive layer 18, the capacity measured becomes smaller and, consequentially, this results in a downward deviation out of the interval of the limit values for the capacity. In this manner, parts are found that include contaminations that cause a larger layer thickness. If an air inclusion exists, the actual relative dielectric constant will be smaller than expected. This also results in a downward deviation of the measured capacity. If no adhesive is present below the substrate in a defined area, the vacuum will cause the plate to contact the body 2 with its full surface, but not sufficiently fixed. All relevant errors in the adhesion are thus detected by this kind of measuring so that a delivery of defective parts can be reliably avoided.

This method is thus suited for measuring adhesive layers that are extremely thin and thermally well conductive so that a failure of the electronics can be reliably avoided, even at high thermal loads, by providing full-surface, thin adhesive layers.

The scope of protection of the application is not restricted to the embodiment described. Various modifications and extensions for the optimization of the method, such as a definition of the measuring points and the automation of the measuring, are conceivable without departing from the scope of protection of the main claim. Reference should be had to the appended claims.

What is claimed is:

1-5. (canceled)

6. A method of verifying a correct adhesion of a substrate on a body which is configured to be electrically conductive and thermally conductive, the method comprising:
providing the body;
providing the substrate comprising a top face and a rear face;
connecting to the top face of the substrate an electric circuit comprising conductive paths and electronic components;
attaching to the rear face the body via an adhesive layer comprising an adhesive;
connecting the conductive paths and the body to an respective opposite terminal of a voltage source via contact tabs;
measuring a capacity; and
determining a quality of the adhesive layer from the measured capacity.

7. The method as recited in claim 6, wherein the electric circuit further comprises supply contacts, the contact tabs being connected with the conductive paths via the supply contacts.

8. The method as recited in claim 6, further comprising as a first step determining a dielectric constant of the adhesive.

9. The method as recited in claim 6, further comprising performing an offset compensation prior to connecting the conductive paths and the body to the contact tabs.

10. The method as recited in claim 6, further comprising:
comparing the measured capacity with an upper limit value and a lower limit value for the capacity; and
determining a correct adhesion quality based on whether the measured capacity falls into an interval between the upper limit value and the lower limit value.
